(19) United States
(12) Patent Application Publication
(10) Pub. No.: US 2026/0192224 A1
(43) Pub. Date: Jul. 9, 2026

(54) DEMISTER

(71) Applicant: MITSUBISHI HEAVY INDUSTRIES, LTD., Tokyo (JP)

(72) Inventors: Satoshi YONEMOTO, Tokyo (JP); Minoru YOSHIMOTO, Tokyo (JP); Kazuhiro IMAI, Tokyo (JP); Ichiro MAEDA, Tokyo (JP)

(73) Assignee: MITSUBISHI HEAVY INDUSTRIES, LTD., Tokyo (JP)

(21) Appl. No.: 19/129,541

(22) PCT Filed: Sep. 12, 2023
(86) PCT No.: PCT/JP2023/033213

§ 371 Date: May 13, 2025

(30) Foreign Application Priority Data
Nov. 16, 2022 (JP) 2022-183218

(51) Int. Cl. B01D 45/08

(52) U.S. Cl. CPC B01D 45/08

(57) ABSTRACT

A demister includes a plurality of vanes including a leading edge portion, a trailing edge portion, and a main body portion, the plurality of vanes being arrayed at an interval in an array direction intersecting a flow direction. The thickness of the leading edge portion gradually increases from a downstream side toward the main body portion. The thickness of the trailing edge portion gradually decreases from the main body portion toward the downstream side. The main body portion includes a convex curved surface curved to be convex toward one side in the array direction, and a concave curved surface provided on a side opposite to the convex curved surface and curved to be concave toward the one side in the array direction. A capturing portion capturing particles is formed on the downstream side of a start point at which a curvature in the main body portion starts to be changed.

### TECHNICAL FIELD

The present disclosure relates to a demister.

Priority is claimed on Japanese Patent Application No. 2022-183218, filed on Nov. 16, 2022, the content of which is incorporated herein by reference.

### BACKGROUND ART

In various fluid machines including an engine, there is a request to remove foreign substances such as water droplets and particles from a fluid on a path for suctioning the fluid. In order to remove these foreign substances, a device called a demister is widely used (for example, Patent Document 1). In the device disclosed in Parent Document 1 below, a flow path is formed by arraying a plurality of vanes extending in a zigzag shape inside a duct. While the fluid flows in the flow path, a flow direction of the fluid is changed by the vane having a thin plate shape extending in the zigzag shape, but the foreign substances cannot follow a change in the flow direction due to an inertial force of the foreign substances themselves and fall outside a flow of the fluid. That is, the foreign substances adhere to a surface of the vane. In this manner, the foreign substances can be removed from the fluid.

### CITATION LIST

### Patent Document

Patent Document 1: United States Patent Application Publication No. 2008/0142430

### SUMMARY OF INVENTION

### Technical Problem

However, when the vane is formed of a simple thin plate as described above, the flow direction of the fluid is rapidly changed to cause flow separation or the like. Therefore, a pressure loss increases. As a result, there is a problem in that a desired fluid flow rate cannot be obtained on a downstream side of the demister.

The present disclosure is made to solve the above-described problem, and an object of the present disclosure is to provide a demister in which a pressure loss is reduced.

### Solution to Problem

According to the present disclosure, in order to solve the above-described problem, there is provided a demister including a plurality of vanes including a leading edge portion located on an upstream side in a flow direction of a fluid, a trailing edge portion located on a downstream side in the flow direction, and a main body portion continuously connecting the leading edge portion and the trailing edge portion, the plurality of vanes being arrayed at an interval in an army direction intersecting the flow direction. The thickness of the leading edge portion gradually increases from the downstream side toward the main body portion. The thickness of the trailing edge portion gradually decreases from the main body portion toward the downstream side. The main body portion includes a convex curved surface curved to be convex toward one side in the array direction, and a concave curved surface provided on a side opposite to the convex curved surface and curved to be concave toward the one side in the array direction. A capturing portion capturing particles included in the fluid flowing on a surface of the main body portion is formed on the downstream side of a start point at which a curvature in the main body portion starts to be changed.

### Advantageous Effects of Invention

According to the present disclosure, it is possible to provide a demister in which a pressure loss is reduced,

### BRIEF DESCRIPTION OF DRAWINGS

FIG. 1 A cross-sectional view representing the configuration of a demister according to an embodiment of the present disclosure,

FIG. 2 An enlarged view representing the configuration of a vane according to the embodiment of the present disclosure.

FIG. 3 A perspective view representing an example of an internal configuration of the vane according to the embodiment of the present disclosure.

FIG. 4 A perspective view representing a modification example of the internal configuration of the vane according to the embodiment of the present disclosure.

### DESCRIPTION OF EMBODIMENTS

### Configuration of Demister

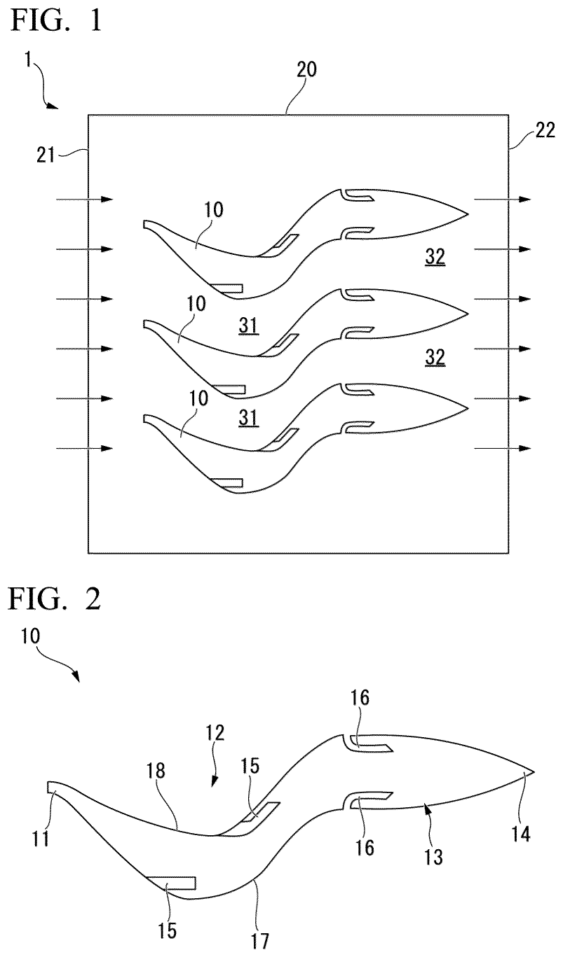

Hereinafter, a demister 1 according to an embodiment of the present disclosure will be described with reference to FIGS. 1 to 3. For example, the demister 1 according to the present embodiment is provided on an intake path of an engine or the like, and is used to remove foreign substances such as water droplets and particles from a fluid flowing into the engine or the like.

As represented in FIG. 1, the demister 1 includes a plurality of (for example, three) vanes 10 and a housing 20 surrounding the vanes 10 from an outside. In the housing 20, an inlet 21 that is open toward an upstream side in a flow direction of the fluid and an outlet 22 that is open toward a downstream side are formed. In the following description, a direction connecting the inlet 21 and the outlet 22 will be simply referred to as the “flow direction”, and a side on which the inlet 21 is located when viewed from the outlet 22 will be simply referred to as an “upstream side”. In addition, the opposite side is simply referred to as the “downstream side”.

Each of the plurality of vanes 10 extends in the flow direction, and the plurality of vanes 10 are disposed at an interval in an array direction which is a direction intersecting the flow direction. The plurality of vanes 10 are located at the same position in the flow direction, Depending on designs or specifications, a front-rear difference may be provided at the positions of the vanes 10.

### Configuration of Vane

As represented in FIG. 2, each of the vanes 10 includes a leading edge portion 11, a main body portion 12, a flow straightening portion 13, a trailing edge portion 14, a capturing portion 15, and an auxiliary capturing portion 16. The leading edge portion 11 forms an end portion of the vane 10 on a most upstream side. The dimension (that is, the thickness) of the leading edge portion 11 in the array direction gradually increases from the upstream side to the downstream side, Hereinafter, the dimension in the array direction will be simply referred to as the “thickness”.

The main body portion 12 is integrally connected to the downstream side of the leading edge portion 11. The main body portion 12 has a convex curved surface 17 and a concave curved surface 18. The convex curved surface 17 faces one side in the array direction. The convex curved surface 17 is curved to be convex toward one side in the array direction. In addition, an end portion of the convex curved surface 17 on the upstream side and an end portion of the leading edge portion 11 on the downstream side are smoothly connected to each other to form a continuous curved surface. That is, a step difference or the like is not formed between the end portions.

The concave curved surface 18 faces the other side in the array direction. The concave curved surface 18 is curved to be concave toward one side in the array direction. In addition, an end portion of the concave curved surface 18 on the upstream side and an end portion of the leading edge portion 11 on the downstream side are smoothly connected to each other to form a continuous curved surface. That is, a step difference or the like is not formed between the end portions.

Capturing portions 15 for capturing foreign substances such as particles included in the flow of the fluid are formed on the convex curved surface 17 and the concave curved surface 18. The capturing portion 15 is disposed on the downstream side of a start point at which a curvature in the convex curved surface 17 and the concave curved surface 18 starts to be changed. That is, the foreign substances such as the particles are captured when the flow of the fluid cannot follow the curved surfaces du to a change in the curvature. Each of the capturing portions 15 is a concave groove buried inward of the contour line of the main body portion 12. That is, the capturing portion 15 does not protrude outward from the contour lines of the convex curved surface 17 and the concave curved surface 18. In addition, the inlet opening of the capturing portion 15 is open toward the upstream side.

A flow straightening portion 13 is integrally connected to a downstream side of the main body portion 12. The flow straightening portion 13 extends from an end portion of the main body portion 12 on a downstream side in the flow direction toward the downstream side. On both surfaces of the flow straightening portion 13 in the thickness direction, each of auxiliary capturing portions 16 having the same function as the capturing portion 15 is provided. The auxiliary capturing portion 16 is also a concave groove buried inward of a contour line of the flow straightening portion 13. That is, the auxiliary capturing portion 16 does not protrude outward from the contour line of the flow straightening portion 13. In addition, the inlet opening of the capturing portion 15 is open toward the upstream side. The auxiliary capturing portion 16 is disposed on a slightly downstream side of an end portion of the flow straightening portion 13 on the upstream side. A pair of the auxiliary capturing portions 16 on both sides in a thickness direction are located at the same position in the flow direction.

The trailing edge portion 14 is integrally connected to the downstream side of the flow straightening portion 13. The thickness of the trailing edge portion 14 gradually decreases from the upstream side toward the downstream side. An end portion of the trailing edge portion 14 on the downstream as a pointed shape that is convex toward the downstream side. That is, the thickness increases from the leading edge portion 11 to the main body portion 12 and the flow straightening portion 13, and thereafter, the thickness gradually decreases toward the trailing edge portion 14. In this manner, the vane 10 has a streamlined shape in a cross section. In addition, a surface from the leading edge portion 11 to the trailing edge portion 14 via the convex curved surface 17 is formed of a single continuous curved surface. Similarly, a surface from the leading edge portion 11 to the trailing edge portion 14 via the concave curved surface 18 is formed of a single continuous curved surface.

As represented in FIG. 1, the vanes 10 configured as described above are disposed such that some of the vanes are superposed on each other (that is, to overlap each other) when viewed in the flow direction. Therefore, a flow path cross-sectional area of an inter-vane flow path 31 formed between the vanes 10 gradually decreases toward the downstream side in a region from the leading edge portion 11 to the main body portion 12 and the flow straightening portion 13, and the flow path cross-sectional area gradually increases toward the downstream side in a diffuser flow path 32 formed in a region from the flow straightening portion 13 to the trailing edge portion 14.

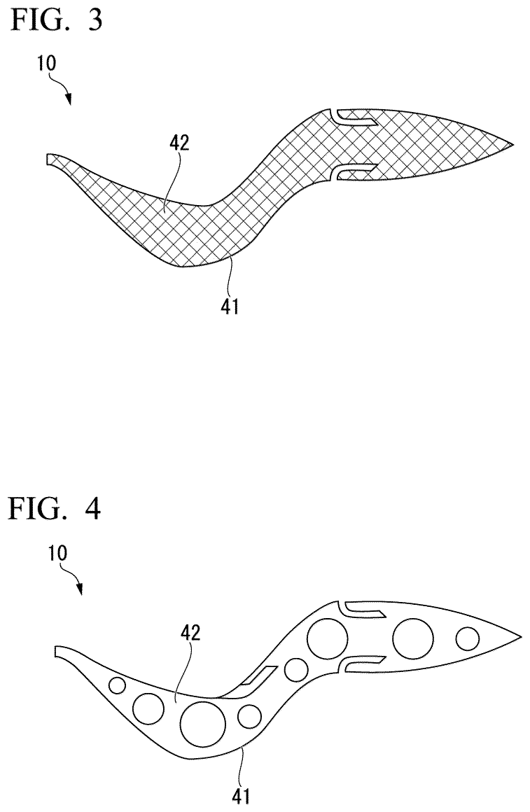

Next, an internal structure of the vane 10 will be described with reference to FIG. 3, The vane 10 includes an outer skin material 41 and a structural member 42. The outer skin material 41 forms each surface of the above-described vane 10. For example, it is desirable that the outer skin material 41 is integrally formed by three-dimensional laminate shaping. The structural member 42 is a member for ensuring strength and rigidity of the outer skin material 41 by being disposed inside the outer skin material 41. As an example, the structural member 42 is formed of a plurality of beans connecting inner surfaces of the outer skin material 41. In addition, it is desirable that this structural member 42 is also formed to be integrated with the outer skin material 41 by three-dimensional laminate shaping. That is, the vane 10 has a monocoque structure.

### Operational Effect

In operating the above-described demister 1, first, the fluid is caused to flow from the inlet 21 to the outlet 22. When the fluid flows into the inter-vane flow path 31. the flow direction of the fluid is changed to follow a curved surface shape of the vane 10. In this case, whereas the fluid follows the flow, the foreign substances such as the particles or the water droplets deviate from the flow due to the weight of the foreign substances. The foreign substances deviating from the flow are captured by the capturing portion 15 described above, and are discharged outward. Thereafter, in the diffuser flow path 32, a flow velocity of the fluid rising in the inter-vane flow path 31 decreases, and a fic pressure is recovered. In this state, for example, the fluid is fed to other external equipment from the outlet 22, and is used in various ways. Depending on an aspect of other external equipment, the fluid can be fed in the same pressure state without causing the fluid to pass through the diffuser flow path 32.

Here, in the demister 1 in the related art, a flow path is formed by arraying a plurality of thin plates extending in a zigzag shape inside a duct. However, when the now path is formed by a simple thin plate as described above, a pressure loss of the fluid inside the demister 1 increases due to a rapid change in the flow direction of the fluid or excessive resistance to the fluid. As a result, there is a problem in that a desired fluid flow rate or pressure cannot be obtained on the downstream side of the demister 1. Therefore, the demister 1 according to the present embodiment adopts each configuration described above.

According to the above-described configuration, the thickness of the vane 10 increases from the leading edge portion 11 to the main body portion 12, and the thickness of the vane 10 decreases from the main body portion 12 to the trailing edge portion 14. That is, a cross-sectional shape of the vane 10 is a streamlined shape. Therefore, when the fluid passes through a periphery of the vane 10, the flow is not disturbed by the vane 10, and stagnation, a vortex, or separation does not occur in a vicinity of the surface of the vane 10. That is, a dead water region is not likely to be formed on the periphery of the vane 10. In this manner, a pressure loss of the flow which is caused by disposing the vane 10 can be reduced. In addition, since the vane 10 has the streamlined shape, a fluid force as resistance acting on the vane 10 is also reduced. Therefore, a load applied to the vane 10 can be reduced, and a support structure of the vane 10 can have a tolerance. As a result, reduced manufacturing costs and a reduced weight of the demister 1 can be realized.

Furthermore, according to the above-described configuration, since the flow straightening portion 13 is provided on the downstream side of the main body portion 12. a flow of the fluid having a desired flow direction can be supplied to equipment on the downstream side of the vane 10. That is, an extending direction of the main body portion 12 may be appropriately changed depending on the flow direction of the fluid. In this manner, restriction on the equipment disposed on the downstream side of the demister 1 is relaxed, and general-purpose properties of the demister 1 can be improved.

In addition, according to abos e-described configuration, each of both surfaces from the leading edge portion 11 to the trailing edge portion 14 is formed of a single continuous curved surface. In other words, a protruding portion of a step difference is not formed on these surfaces. Therefore, disturbance such as a vortex or separation does not occur in the flow flowing along these surfaces. Therefore, the pressure loss of the fluid can be further reduced.

In addition, according to the above-described configuration, since the vanes 10 are superposed on (overlap with) each other, the flow velocity of the fluid gradually increases in the flow path between the vanes 10 (inter-vane flow path 31). In this manner, the particles can be efficiently removed from the fluid by the vane 10.

In addition, according to the above-described configuration, unlike the thin plate in the related art, since the vane 10 as the thickness, the structural member 42 can be disposed inside the outer skin material 41. In this manner, the strength or the rigidity of the vane 10 can be improved. As a result, durability of the demister 1 can be improved, and the demister 1 can be stably used for a long period of time.

Furthermore, according to the above-described configuration, the capturing portion 15 is recessed to be buried inward of the contour line of the vane 10. In this manner, for example, compared to a case where the capturing portion 15 protrudes outward, influence on the flow of the fluid can be minimized. That is, a vortex or separation does not occur in the flow of the fluid. In this manner, an increase in the pressure loss which is caused by disposing the vane 10 can be minimized. Therefore, the equipment connected to the downstream side of the demister 1 can be more stably and smoothly operated. In addition, energy for suctioning the fluid required for the equipment on the downstream side can be minimized. In this manner, energy saving and cost reduction of an entire system including the demister 1 can be realized.

In addition, according to the above-described configuration, since the diffuser flow path 32 is formed between the trailing edge portions 14, a static pressure can be recovered while the velocity of the fluid is reduced. In this manner, the flow velocity or the pressure of the fluid can be optimized in accordance with characteristics of the device used on the downstream side of the demister 1.

Hitherto, the embodiments of the present disclosure have been described. Various changes or modifications can be made to the above-described configuration without departing from the concept of the present disclosure. For example, the number of the vanes 10 represented in FIG. 1 is an example, and the number of the vanes 10 can be appropriately increased or decreased depending on designs or specifications. In addition, the number of the main body portions 12 provided in the vane 10 is also an example, and a plurality of main body portions 12 may be continuously formed. That is, a configuration can be adopted in which the concave curved surface 18 and the convex 15. curved surface 17 are alternately connected. This point may also be appropriately determined depending on the design or the specification. In addition, the shape of the structural member 42 inside the outer skin material 41 may also be appropriately changed depending on designs or specifications. As represented in FIG. 4 as a modification example, a configuration can also be adopted in which a space having a plurality of circular cross sections is formed inside the outer skin material 41 to ensure the strength or the rigidity of the outer skin material 41. In addition, a configuration can also be adopted in which the main body portion 12 and the trailing edge portion 14 are directly connected without providing the flow straightening portion 13 on the downstream side of the main body portion 12. In this case as well, the configuration of the vane 10 may be appropriately determined depending on designs or specifications.

### <Appendix>

For example, the demister 1 described in each embodiment is understood as follows.
(1) The demister 1 according to a first aspect includes the plurality of vanes 10 including the leading edge portion 11 located on the upstream side in the flow direction of the fluid, the trailing edge portion 14 located on the downstream side in the flow direction, and the main body portion 12 continuously connecting the leading edge portion 11 and the trailing edge portion 14, the plurality of vanes 10 being arrayed at an interval in the array direction intersecting the flow direction. The thickness of the leading edge portion 11 gradually increases from the downstream side toward the main body portion 12. The thickness of the trailing edge portion 14 gradually decreases from the main body portion 12 toward the downstream side. The main body portion 12 includes the convex curved surface 17 curved to be convex toward one side in the array direction, and the concave curved surface 18 provided on the side opposite to the convex curved surface 17 and curved to be concave toward the one side in the array direction. The capturing portion 15 capturing the particles included in the fluid flowing on the surface of the main body portion 12 is formed on the downstream side of the start point at which the curvature of the main body portion 12 starts to be changed.

According to the above-described configuration, the thickness of the vane 10 increases from the leading edge portion 11 to the main body portion 12, and the thickness of the vane 10 decreases from the main body portion 12 to the trailing edge portion 14. That is, a cross-sectional shape of the vane 10 is a streamlined shape. Therefore, when the fluid passes through the periphery of the vane 10, the flow is not disturbed by the vane 10, and stagnation or a vortex does not occur. In this manner, a pressure loss of the flow which is caused by disposing the vane 10 can be reduced. In addition, since the fluid force acting on the vane 10 is also reduced, a load applied to the vane 10 is reduced, and a support structure of the vane 10 can have a tolerance
(2) As the demister 1 according to a second aspect, the demister 1 according to (1) may further include the flow straightening portion 13 provided between the main body portion 12 and the trailing edge portion 14 and extending in the flow direction.

According to the above-described configuration, since the flow straightening portion 13 is provided, the flow of the fluid having a desired flow direction can be supplied to the equipment on the downstream side of the vane 10. In this manner, the general-purpose properties of the demister 1 can be improved.
(3) As the demister 1 according to the third aspect, in the demister 1 according to (1) or (2), each of the surface from the leading edge portion 11 to the trailing edge portion 14 via the convex curved surface 17 and the surface from the leading edge portion 11 to the trailing edge portion 14 via the concave curved surface 18 may be formed of the single continuous curved surface.

According to the above-described configuration, each of both surfaces from the leading edge portion 11 to the trailing edge portion 14 may be formed of the single continuous curved surface. In other words, a protruding portion or a step difference is not formed on these surfaces. Therefore, disturbance does not occur in the flow flowing along the surfaces. Therefore, the pressure loss of the fluid can be further reduced.
(4) As the demister 1 according to a fourth aspect, in the demister 1 according to any one of (1) to (3), some of the plurality of vanes 10 may be arrayed to be superposed on each other when viewed in the flow direction.

According to the above-described configuration, since the vanes 10 are superposed on (overlap with) each other, the flow velocity of the fluid increases in the flow path between the vanes 10. In this manner, the particles can be efficiently removed from the fluid by the vane 10.
(5) As the demister 1 according to a fifth aspect, in the demister 1 according to any one of (1) to (4), the vane 10 may include the outer skin material 41 integrally formed to have the outer surface of the leading edge portion 11, the outer surface of the trailing edge portion 14, the convex curved surface 17, and the concave curved surface 18, and the structural member 42 disposed inside the outer skin material 41.

According to the above-described configuration, since the vane 10 has a thickness, the structural member 42 can be disposed inside the outer skin material 41. In this manner, the strength of the rigidity of the vane 10 can be improved. As a result, durability of the demister 1 can be improved, and the demister 1 can be stably used for a long period of time.
(6) As the demister 1 according to a sixth aspect, in the demister 1 according to any one of (1) to (5), the capturing portion 15 may be recessed to be buried inward of the contour line of the vane 10.

According to the above-described configuration, since the capturing portion 15 is recessed to be buried inward of the contour line of the vane 10, for example, compared to a case where the capturing portion 15 protrudes outward, the influence on the flow of the fluid can be minimized. In this manner, an increase in the pressure loss which is caused by disposing the vane 10 can be minimized.
(7) As the demister 1 according to a seventh aspect, in the demister 1 according to any one of (1) to (6), the diffuser flow path 32 in which the flow path cross-sectional area gradually increases toward the downstream side may be formed between the trailing edge portions 14 of a pair of the vanes 10 adjacent to each other in the array direction.

According to the above-described configuration, since the diffuser flow path 32 is formed between the trailing edge portions 14, the static pressure can be recovered while the velocity of the fluid is reduced. In this manner, the flow velocity or the pressure of the fluid can be optimized in accordance with characteristics of the device used on the downstream side of the demister 1.

### INDUSTRIAL APPLICABILITY

According to the present disclosure, it is possible to provide a demister in which a pressure loss is reduced.

### REFERENCE SIGNS LIST

1 Demister
10 Vane
11 Leading edge portion
12 Main body portion
13 Flow straightening portion
14 Trailing edge portion
15 Capturing portion
16 Auxiliary capturing portion
17 Convex curved surface
18 Concave curved surface
20: housing
21 Inlet
22 Outlet
31 Inter-vane flow path
32 Diffuser flow path
41 Outer skin material
42 Structural member

1. A demister comprising:
a plurality of vanes including
a leading edge portion located on an upstream side in a flow direction of a fluid,
a trailing edge portion located on a downstream side in the flow direction, and
a main body portion continuously connecting the leading edge portion and the trailing edge portion,
the plurality of vanes being arrayed at an interval in an array direction intersecting the flow direction,
wherein a thickness of the leading edge portion gradually increases from the downstream side toward the main body portion,
a thickness of the trailing edge portion gradually decreases from the main body portion toward the downstream side,
the main body portion includes a convex curved surface curved to be convex toward one side in the array direction, and a concave curved surface provided on a side opposite to the convex curved surface and curved to be concave toward the one side in the array direction,
a capturing portion capturing particles included in the fluid flowing on a surface of the main body portion is formed on the downstream side of a start point at which a curvature in the main body portion starts to be changed,
the capturing portion includes an upstream-side capturing portion provided on the convex curved surface and the concave curved surface, and a downstream-side capturing portion provided on the downstream side of the upstream-side capturing portion. and
an inlet opening of the upstream-side capturing portion is open toward the upstream side.

2. The demister according to claim 1, further comprising:
a flow straightening portion provided between the main body portion and the trailing edge portion and extending in the flow direction.

3. The demister according to claim 1,
wherein each of a surface from the leading edge portion to the trailing edge portion via the convex curved surface and a surface from the leading edge portion to the trailing edge portion via the concave curved surface is formed of a single continuous curved surface.

4. The demister according to claim 1,
wherein some of the plurality of vanes are arrayed to be superposed on each other when viewed in the flow direction.

5. The demister according to claim 1,
wherein the vane includes an outer skin material integrally formed to have an outer surface of the leading edge portion, an outer surface of the trailing edge portion, the convex curved surface, and the concave curved surface, and a structural member disposed inside the outer skin material.

6. The demister according to claim 1,
wherein the capturing portion is recessed to be buried inward of a contour line of the vane,

7. The demister according to claim 1,
wherein a diffuser flow path in which a flow path cross-sectional area gradually increases toward the downstream side is formed between the trailing edge portions of a pair of the vanes adjacent to each other in the array direction.

8. The demister according to claim 2,
wherein each of a surface from the leading edge portion to the trailing edge portion via the convex curved surface and a surface from the leading edge portion to the trailing edge portion via the concave curved surface is formed of a single continuous curved surface.
